(19) United States
(12) Patent Application Publication
(10) Pub. No.: US 2004/0254692 A1
(43) Pub. Date: Dec. 16, 2004

(54) Method and apparatus for calculating engine power

(75) Inventors: Michael J. Ingram, Melbourne, FL (US); Rick Willard, Camarillo, CA (US); Mark George Lyon, Newtonville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avidyne Corporation, Lincoln, MA (US)

(21) Appl. No.: 10/868,246

(22) Filed: Jun. 14, 2004

Related U.S. Application Data
(60) Provisional application No. 60/478,686, filed on Jun. 13, 2003.

(51) Int. Cl. G06F 7/00

(52) U.S. Cl. 701/3; 701/1

(57) ABSTRACT

A method, computer program, or apparatus for determining with various degrees of precision the power delivered by an engine, typically, an aircraft engine. The disclosed invention uses a variety of parameters, such as the rotation rate, manifold pressure, outside air temperature, and fuel flow to determine or approximate the power delivered by the engine. The engine's altitude does not have to be involved in the calculations.

### RELATED APPLICATIONS

This application claims the benefit of U.S. Provisional Application No. 60/478,686, filed Jun. 13, 2003, the entire teachings of which are incorporated herein by reference.

### BACKGROUND OF THE INVENTION

This invention relates to the broad category of engines which operate by converting the energy of combustion of a mixture comprising fuel and air into a periodic mechanical motion. A variety of such engines is known in the pertinent art. Such engines are widely used on various aircrafts.

In engineering or physical terms, the foregoing mechanical motion is “work” and the rate at which the “work” is done is “power”. The power delivered by an engine is an important value that must be monitored in many situations where an engine is used. Usually the power cannot be measured directly and must be calculated using a variety of values gathered through various measuring means and then mathematically combined to present the user, such as a pilot, with the amount of power delivered by the engine at a given moment.

### SUMMARY OF THE INVENTION

The present invention provides a method, apparatus or a computer program product for determining the power of an engine by (1) obtaining an HP₀, where HP₀ is a mathematical combination of the engine's rotation rate and of the engine's manifold pressure, (2) obtaining an HP_{I}, where HP_{I} is a mathematical combination of the engine's outside air temperature and of the HP₀, or (3) obtaining an HP_{BP}, where HP_{BP} is a mathematical combination of the engine's fuel flow rate and of the HP_{I}.

Such method, apparatus or a computer program may be used with an aircraft engine and does not have to involve the engine's measured altitude.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a graph showing the dependence of a Teledyne Continental IO-360-ES engine's actual full throttle power output on manifold pressure at different rates of the engine's rotation at sea level under ISA conditions.

FIG. 2 is a graph showing a typical dependence of the calculated power output of a Teledyne Continental IO-360-ES engine on the fuel flow into the engine.

FIG. 3 is a graph showing a typical dependence of discrepancies between the actual and calculated power produced by a Teledyne Continental IO-360-ES engine on the engine's altitude at ISA conditions.

FIG. 4 is a graph showing a typical dependence of discrepancies between the actual and calculated power produced by a Teledyne Continental IO-360-ES engine on the engine's altitude at ISA-30° C. conditions.

FIG. 5 is a graph showing a typical dependence of discrepancies between the actual and calculated power produced by a Teledyne Continental IO-360-ES engine on the engine's altitude at ISA+30° C. conditions.

FIG. 6 is a graph showing the dependence of a Teledyne Continental IO-550-N engine's actual full throttle power output on manifold pressure at different rates of the engine's rotation at sea level under ISA conditions.

FIG. 7 is a graph showing a typical dependence of the calculated power output of a Teledyne Continental IO-550-N engine on the fuel flow into the engine.

FIG. 8 is a graph showing a typical dependence of discrepancies between the actual and calculated power produced by a Teledyne Continental IO-550-N engine on the engine's altitude at ISA conditions.

FIG. 9 is a graph showing a typical dependence of discrepancies between the actual and calculated power produced by a Teledyne Continental IO-550-N engine on the engine's altitude at ISA-30° C. conditions.

FIG. 10 is a graph showing a typical dependence of discrepancies between the actual and calculated power produced by a Teledyne Continental IO-550-N engine on the engine's altitude at ISA+30° C. conditions.

FIG. 11 a flow chart of one embodiment of the present invention.

### DETAILED DESCRIPTION OF THE INVENTION

A description of preferred embodiments of the invention follows.

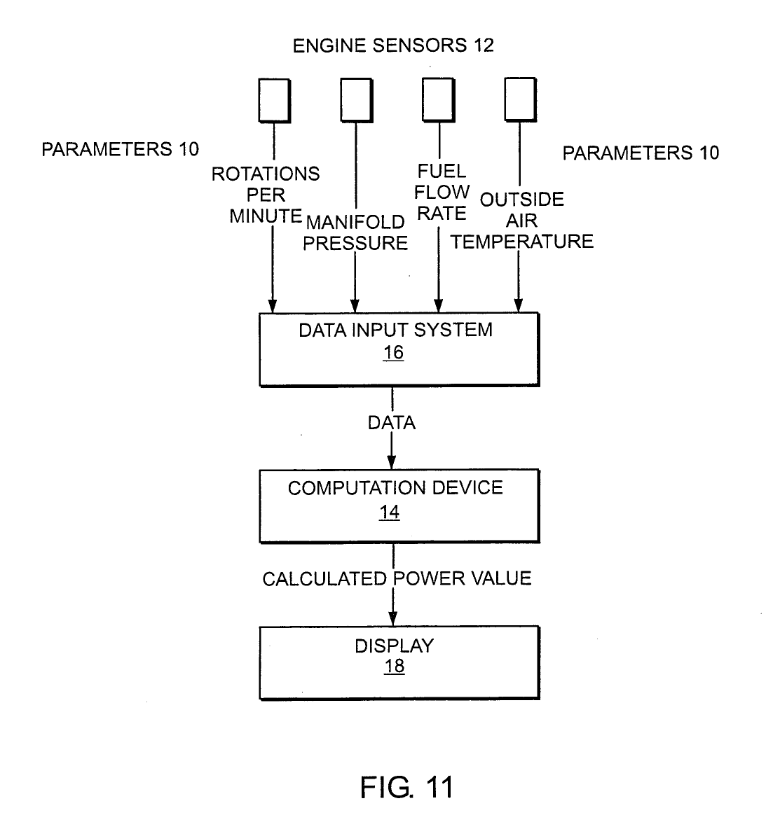

With reference to FIG. 11, the embodiments of this invention use a variety of parameters 10 in determining the power output of an engine (hereinafter expressed in horsepower units). The parameters 10 may include RPM (number of engine rotations per minute), manifold pressure (pressure on the engine's air intake, hereinafter expressed in inches of mercury, inches Hg), outside air temperature (hereinafter expressed in degrees Celsius, ° C.), and fuel flow into the engine (hereinafter expressed in gallons per hour, GPH).

Respective sensors 12, as typically used in aircraft, generate the values of these parameters 10. The values of these parameters are received at an input system 16 and fed into a computation device 14. The computation device 14 may be a microchip or a computer running a software program mathematically combining the values of the parameters 10. The number produced by the computation device 14 representing an approximate value of the engine's power output is sent from the computation device 14 to a display system 18 to be presented to the engine's user. The engine's power output value may be presented, for example, as a number on a numeric display, as a position of an arrow on a meter, scale or the like, etc. In some embodiments, the user is presented not with an absolute value but with the percentage or ratio of the current power output and some fixed value, such as the maximum power output of the engine.

In some embodiments, the computation device 14 mathematically combines the detected engine's rotation rate and manifold pressure to obtain an HP₀ value (one approximation of the power delivered by the engine). Subsequently, the computation device 14 mathematically combines the detected outside air temperature of the engine and HP₀ to obtain an HP_{I} value (another approximation of the power delivered by the engine). The computation device 14 then may mathematically combine the detected engine's fuel rate and HP_{I} value to obtain an HP_{BP} value (a third approximation of the power delivered by the engine). Each of HP₀, HP_{I}, and HP_{BP} are further explained in the examples below.

Accordingly, some embodiments of this invention determine the engine's power output by making progressively better approximations of the value sought by incorporating additional parameters into the calculations.

The term “ISA conditions” is used in the pertinent art and throughout this specification in the sense of the ambient sea level temperature being 15° C. A usual assumption made for ISA conditions is a temperature decrease of 1.98° C. per 1000 feet of altitude increase.

One embodiment of this invention is used to measure the power output of a Teledyne Continental IO-360-ES engine installed on Cirrus Design Corporation's SR-20 aircraft. The maximum power output of this engine is 200 horsepower.

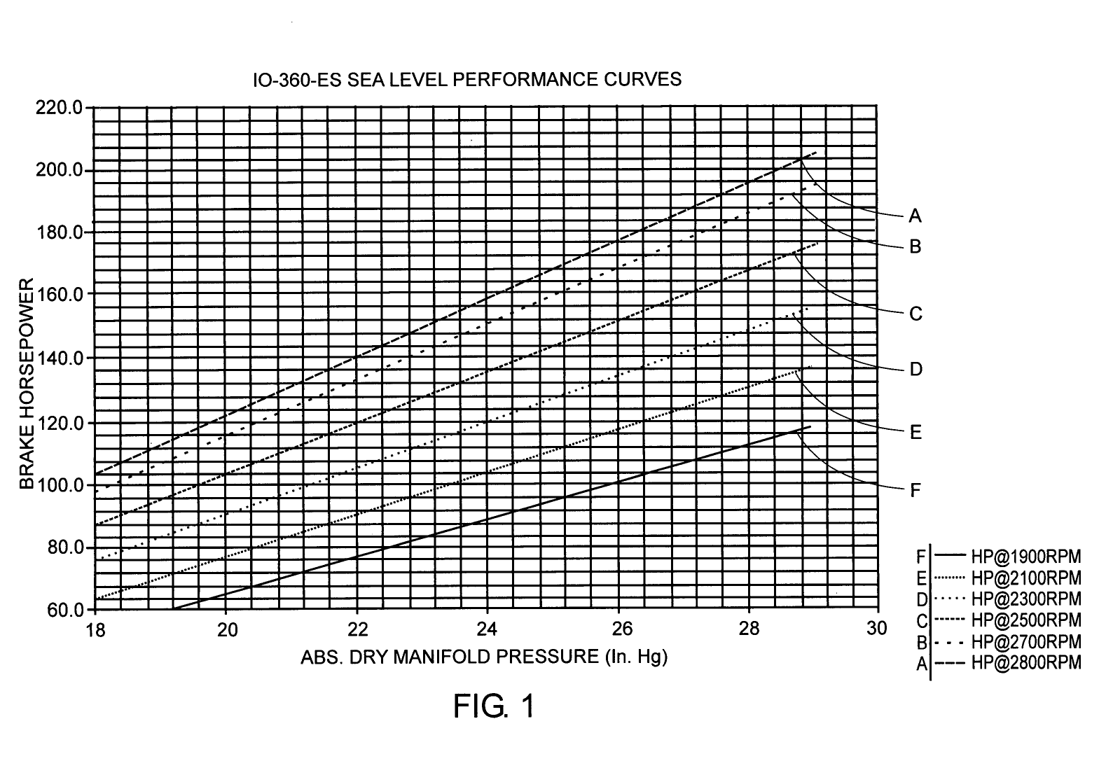

FIG. 1 shows the dependence of the engine's actual full throttle power output (expressed on the vertical axis in horsepower) on manifold pressure (expressed on the horizontal axis in inches Hg) for different rates of the engine's rotation (expressed in RPM) at the sea level under the ISA conditions.

For this engine, the power output may be approximately calculated as HP₀ using manifold pressure, P, and engine rotations per minute, R, as

HP₀=−22.−0.009×R−1.15×P+0.00366×P×R.

A better approximation of the power output, HP_{I}, may be calculated by taking into account the outside air temperature, T, as

HP_{I}=HP₀×((15.−T)×0.0062+1.).

Note that HP_{I}=HP₀ when T=15° C.

The precision of the power output calculation may be further improved under the following combination of conditions:

(1) HP_{I} is between 30% and 80% of the maximum power output of the engine;

(2) the fuel flow into the engine, F, is less than 12.5 gallons per minute; and

(3) F<0.063×HP_{I}+5.

If the above conditions are true, the improved approximation for the engine's power output, HP_{BP}, at a given fuel flow, F, may be calculated as

if F<(F_{BP}−3.), i.e. lean mix,

HP_{BP}=HP_{I}−1.96×(−3.)²+1.06×(−3.);

if (F_{BP}−3.)≦F≦F_{BP},

HP_{BP}=HP_{I}+(−1.96×(F−(0.064×HP_{I}+2.51))²+1.06×(F−(0.064×HP_{I}+2.51)); and

if F_{BP}<F, i.e. rich mix,

HP_{BP}=HP_{I}+(−0.421×(F−(0.064×HP_{I}+2.51))−0.628);

where F_{BP} is the fuel flow at which the engine operates at its best power for the given manifold pressure, rotation rate, and outside air temperature. F_{BP} is the fuel flow based on the engine specifications curve estimated by the equation

F_{BP}=0.064×HP_{I}+2.51

F_{BP} is a curve for the full rich value at specific HP_{BP}. Typically, F_{BP} is in the range from 8.5 to 16. gallons per hour.

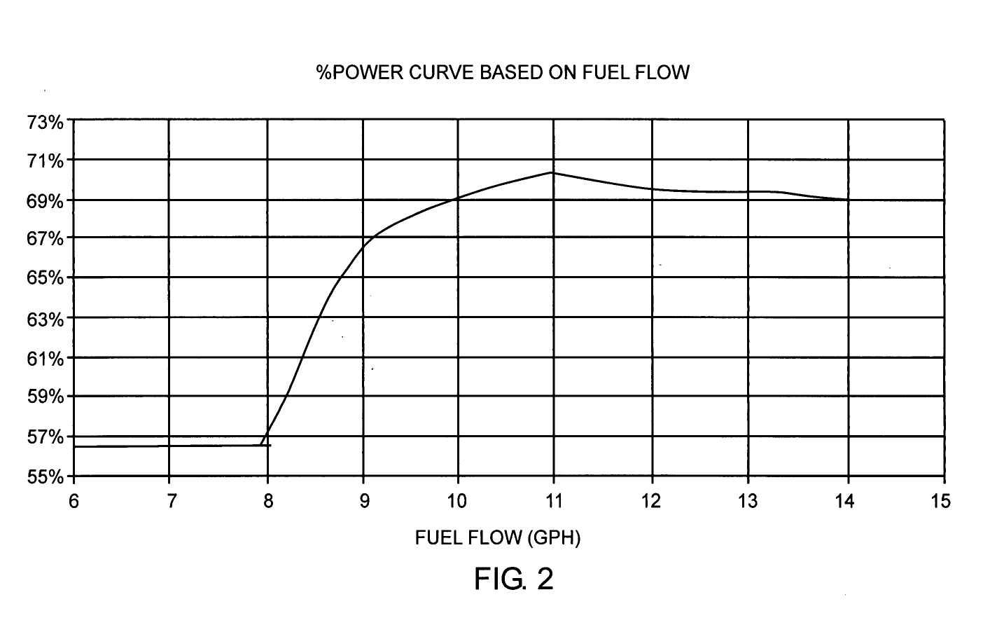

FIG. 2 shows a typical dependence of the power output of the engine (expressed on the vertical axis as percentage of the engine's maximum power) calculated as HP_{BP} on the fuel flow into the engine (expressed on the horizontal axis in gallons per hour) at a fixed value of HP_{I}.

Note that the methods for calculating the engine's power used in this embodiment do not depend on the engine's altitude, which is an important advantage of this embodiment of the invention. In other words, the computation device 14 (FIG. 11) does not employ the measured or sensed aircraft altitude in its operations when producing values HP₀, HP_{I} and HP_{BP} for subsequent display on display 18 (FIG. 11).

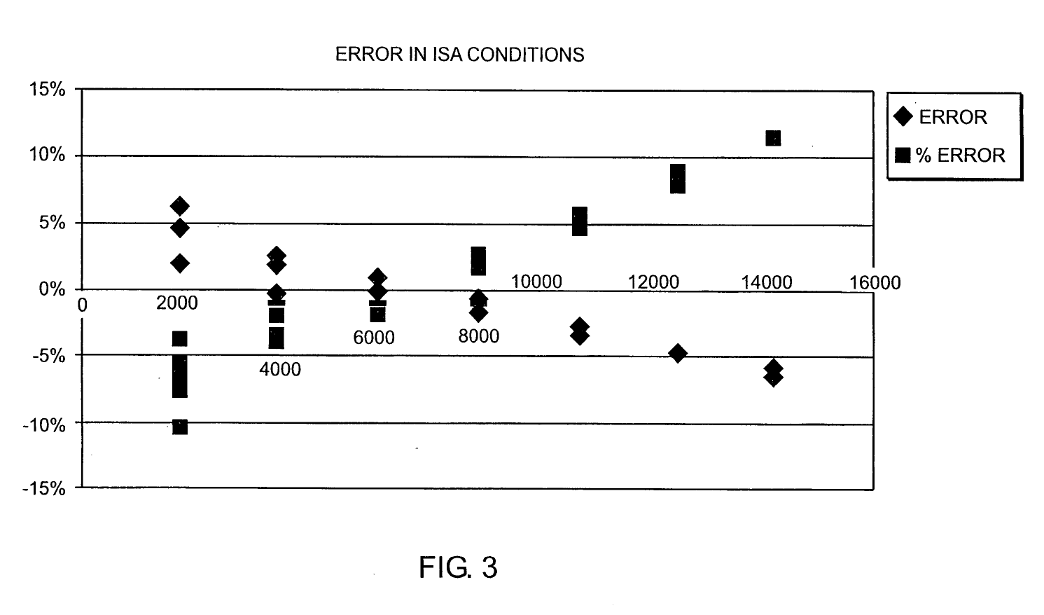

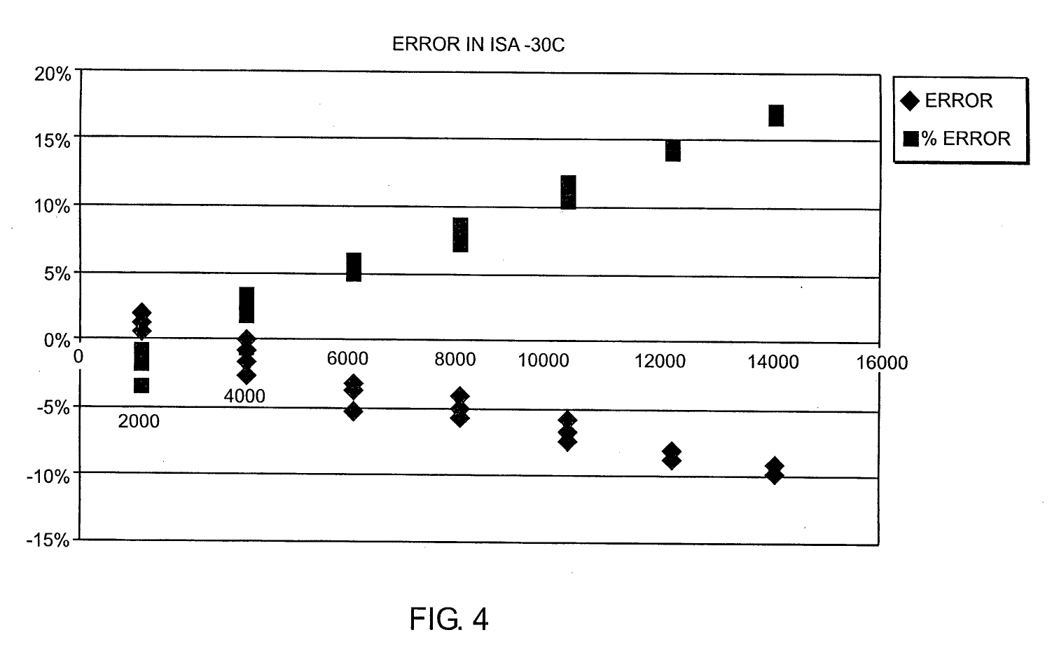

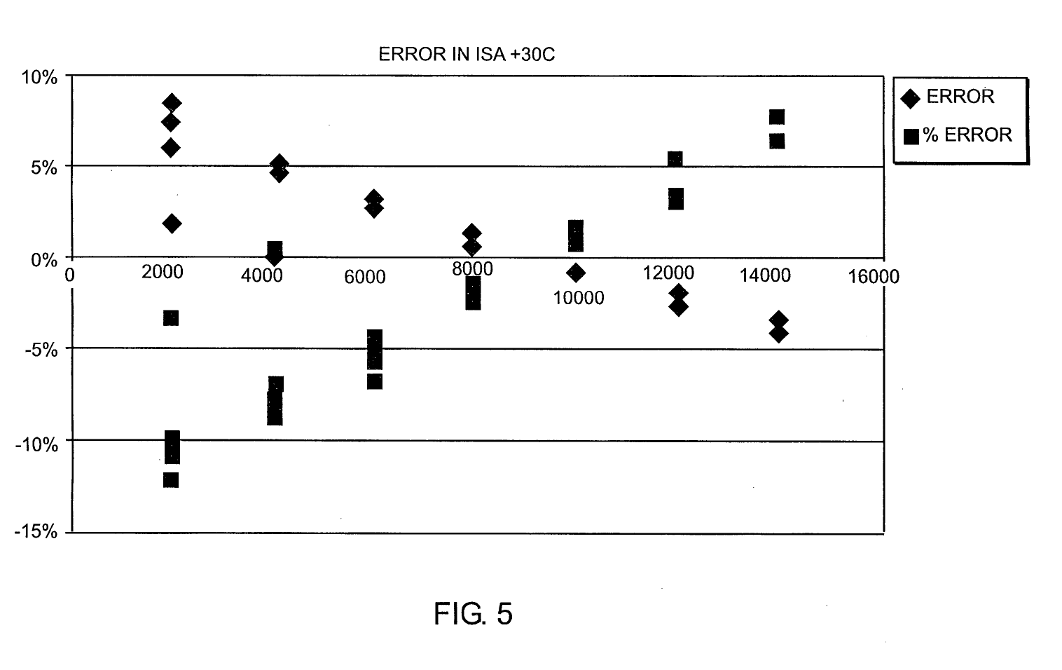

FIGS. 3, 4, and 5 show a typical dependence of discrepancies between the actual power produced by the engine and HP_{I} and HP_{BP} (where available) on the engine's altitude (expressed on the horizontal axis in feet) at ISA conditions (FIG. 3), at ISA −30° C. (i.e., ambient sea level temperature being −15° C., FIG. 4), and at ISA+30° C. (i.e., ambient sea level temperature being 45° C., FIG. 5). In FIGS. 3, 4, and 5, the discrepancies produced by the above method for this engine are shown by diamonds as difference between the calculated and actual engine power (expressed as percentage of the engine's maximum power) and by squares as the percentage difference between the calculated and actual engine's power.

As can be seen from FIGS. 3, 4, and 5, at the ISA conditions, the invention method for this engine works the best (has lower error) between approximately 6,000 and 8,000 feet of altitude.

Another embodiment of this invention is used to measure the power output of a Teledyne Continental IO-550-N engine installed on Cirrus Design Corporation's SR-22 aircraft. The maximum power output of this engine is 310 horsepower.

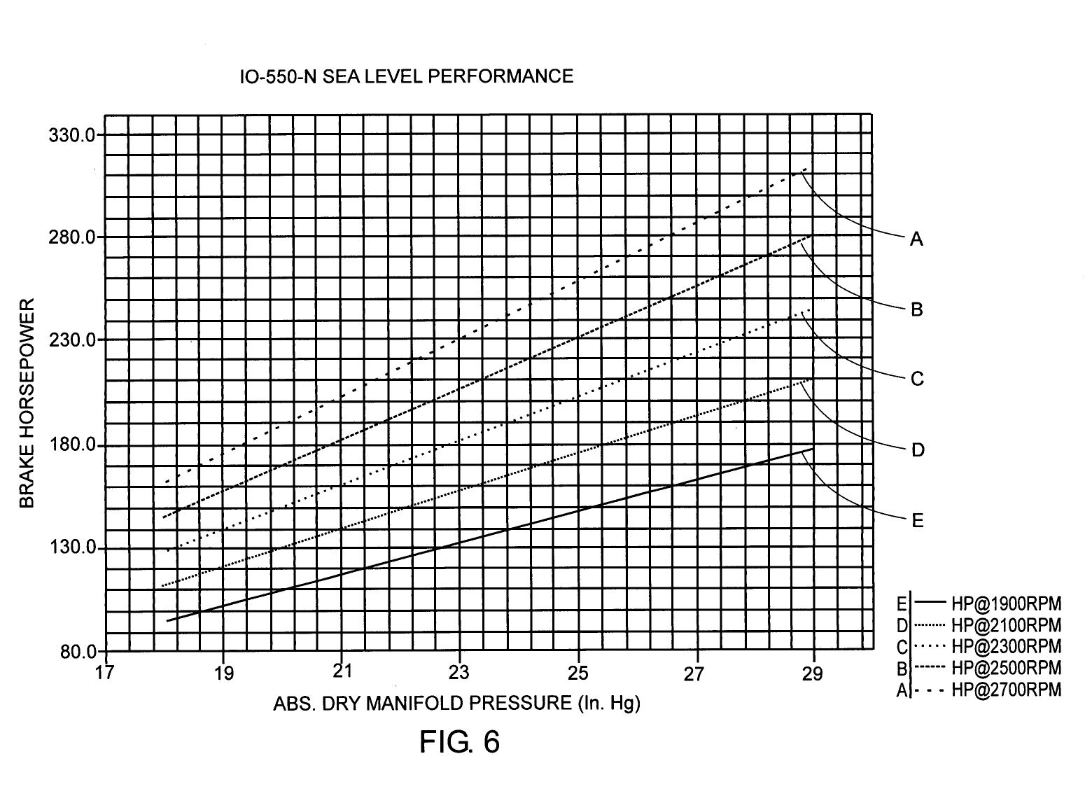

FIG. 6 shows the dependence of the engine's actual full throttle power output (expressed on the vertical axis in horsepower) on manifold pressure (expressed on the horizontal axis in inches Hg) for different rates of the engine's rotation (expressed in RPM) at sea level under the ISO conditions.

For this engine, the power output may be approximately calculated as HP₀ using manifold pressure, P, and engine rotations per minute, R, as

HP₀=86.−0.0543×R−7.×P+0.0077×P×R.

A better approximation of the power output, HP_{I}, may be calculated by taking into account the outside air temperature, T, as

HP_{I}=HP₀×((16.−T)×0.02+1.).

Note that HP_{I}=HP₀ when T=16° C.

The precision of the power output calculation may be further improved under the following combination of conditions:

(1) HP_{I} is between 30% and 80% of the maximum power output of the engine;

(2) the fuel flow into the engine, F, is less than 18.0 gallons per minute; and

(3) F<0.063×HP_{I}+5.

If the above conditions are true, the improved approximation for the engine's power output, HP_{BP}, at a given fuel flow, F, may be calculated as

if F<(F_{BP}−3.), i.e. lean mix,

HP_{BP}=HP_{I}−(0.00151×(−3.)³+2.99×(−3.)²−(−3.)−0.1935);

if (F_{BP}−3.)≦F≦F_{BP},

HP_{BP}=HP_{I}+(0.00151×(F−(0.048×HP_{I}+4.15))³)+(−2.99×(F−(0.048×HP_{I}+4.15))²)−(F−(0.048×HP_{I}+4.15))−0.1935; and

if F_{BP}<F, i.e. rich mix,

HP_{BP}=HP_{I}+(−0.421×(F−(0.048×HP_{I}+4.15))−0.628);

where F_{BP} is the fuel flow at which the engine operates at its best power for the given manifold pressure, rotation rate, and outside air temperature. F_{BP} is the fuel flow based on the engine specifications curve estimated by the equation

F_{BP}=0.048×HP_{I}+4.15

F_{BP} is a curve for the full rich value at specific HP_{BP}. Typically, F_{BP} is in the range from 8. to 15. gallons per hour

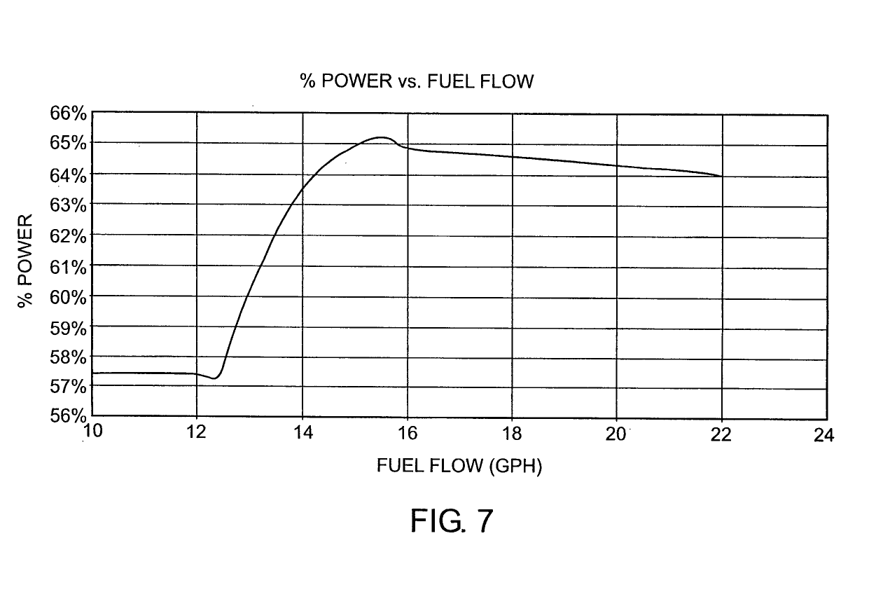

FIG. 7 shows a typical dependence of the power output of the engine (expressed on the vertical axis as percentage of the engine's maximum power) calculated as HP_{BP} on the fuel flow into the engine (expressed on the horizontal axis in gallons per hour) at a fixed value of HP_{I}.

Note that the methods for calculating the engine's power used in this embodiment do not depend on the engine's altitude, which is an important advantage of this embodiment of the invention. In other words, the computation device 14 (FIG. 11) does not employ the measured or sensed aircraft altitude in its operations when producing values HP₀, HP_{I}, and HP_{BP} for subsequent display on display 18 (FIG. 11).

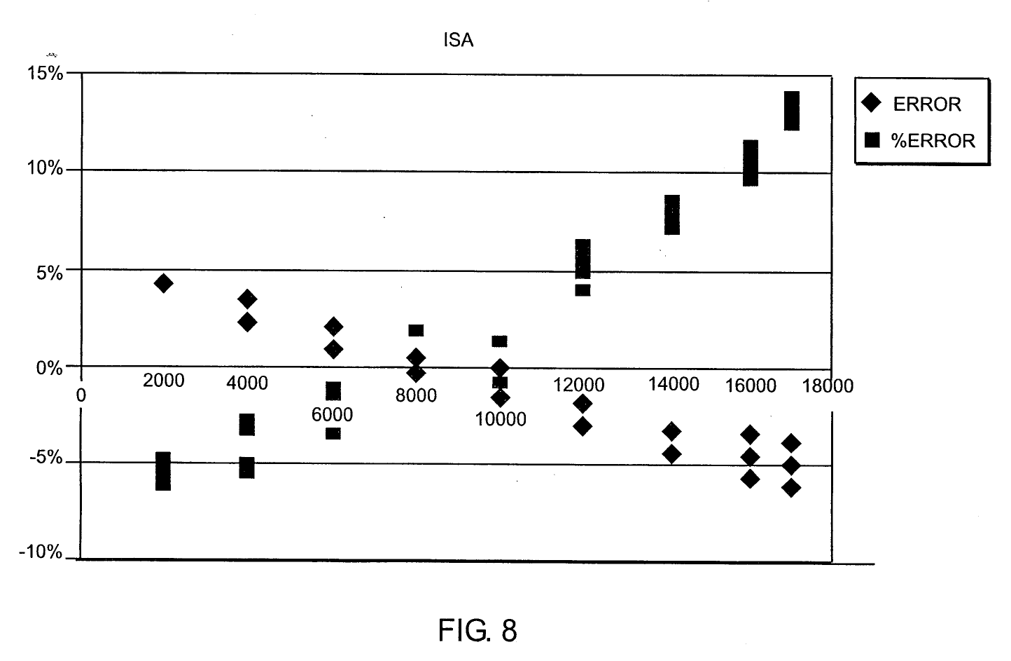

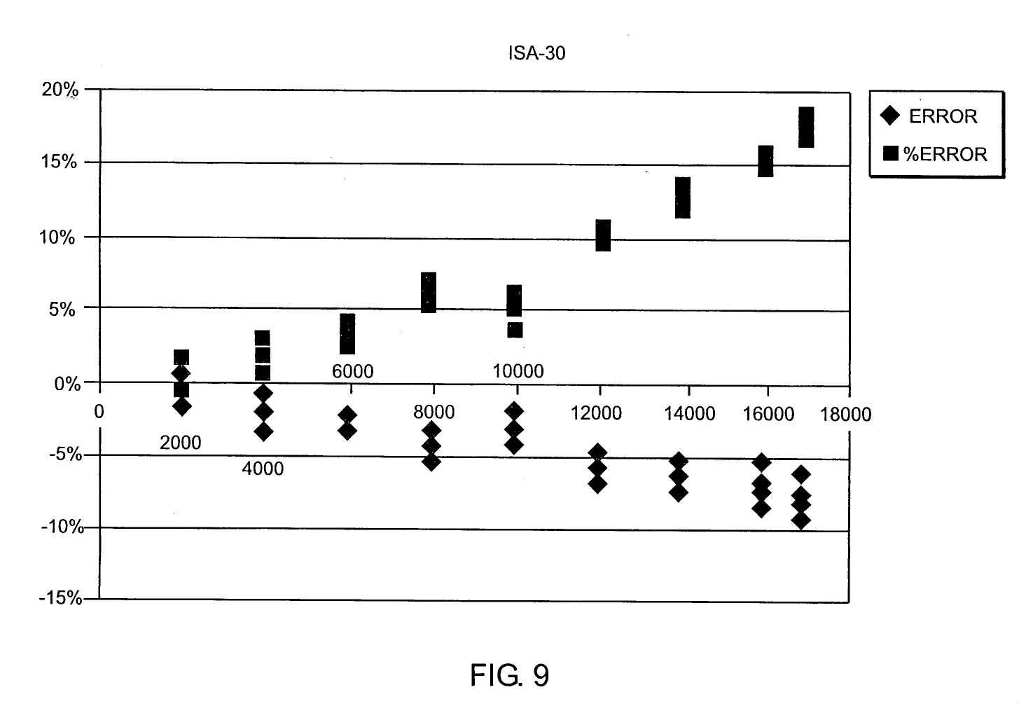

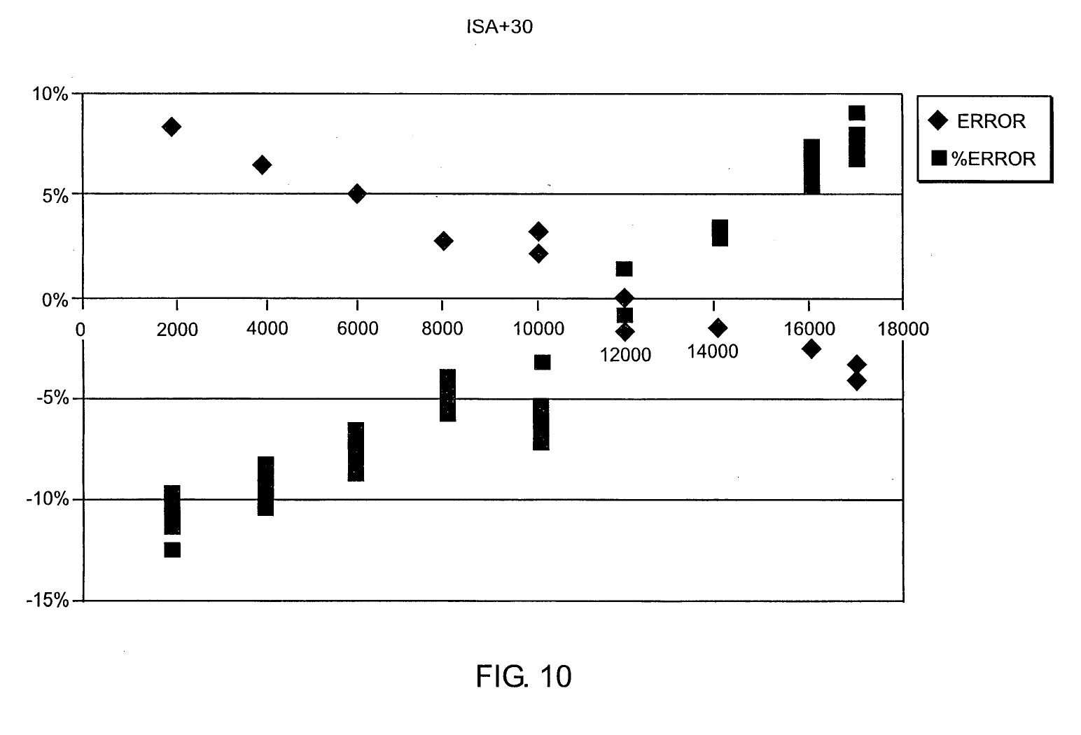

FIGS. 8, 9, and 10 show a typical dependence of discrepancies between the actual power produced by the engine and HP_{I} and HP_{BP} (where available) on the engine's altitude (expressed on the horizontal axis in feet) at ISA conditions (FIG. 8), at ISA −30° C. (i.e., ambient sea level temperature being −15° C., FIG. 9), and at ISA +30° C. (i.e., ambient sea level temperature being 45° C., FIG. 10). In FIGS. 8, 9, and 10, the discrepancies produced by the above method for this engine are shown by diamonds as difference between the calculated and actual engine power (expressed as percentage of the engine's maximum power) and by squares as the percentage difference between the calculated and actual engine's power.

As can be seen from FIGS. 8, 9, and 10, at the ISA conditions, the invention method for this engine works the best (has the lower error) between approximately 6,000 and 8,000 feet of altitude.

Some embodiments including the ones shown above implement the following general approach.

The power output of an engine may be approximately calculated as HP₀ using manifold pressure, P, and engine rotations per minute, R, as

HP₀=A₁+A₂×R+A₃×P+A₄×P×R,

where A₁ through A₄ are coefficients which may be obtained from the engine's manufacturer, obtained by analysis of the engine's design and use, or measured directly by operating the engine under various conditions. Note that the power output HP₀ depends linearly on both the manifold pressure, P, and the engine rotations per minute, R, as can also be observed on FIGS. 1 and 6.

A better approximation of the power output, HP_{I}, may be calculated by taking into account the outside air temperature, T, as:

HP_{I}=HP₀×((T₀−T)×B+1.),

where B and T₀ are coefficients which may be obtained from the engine's manufacturer, obtained by analysis of the engine's design and use, or measured directly by operating the engine under various conditions. Note that HP_{I}=HP₀ when T=T₀. In one embodiment, T₀ is in the range 14° C. to 18° C.

The precision of the power output calculation may be further improved under the following combination of conditions:

(1) HP_{I} is between 30% and 80% of the maximum power output of the engine;

(2) the fuel flow into the engine, F, is less than Fₘₐₓ gallons per minute; and

(3) F<C_{I}×HP_{I}+C₂

If the above conditions are true, the improved approximation for the engine's power output, HP_{BP}, at a given fuel flow, F, may be calculated as

if F<(F_{BP}−F₀), i.e. lean mix,

HP_{BP}=HP_{I}−D₀,

note that this value is constant for constant HP_{I};

if (F_{BP}−F₀)≦F≦F_{BP},

HP_{BP}=HP_{I}+(D₃×(F−(D_{I}×HP_{I}+D₂))³)+(D₄×(F−(D_{I}×HP_{I}+D₂))²)+(D₅×(F−(D_{I}×HP_{I}+D₂)))+D₆; and

if F_{BP}<F, i.e. rich mix,

HP_{BP}=HP_{I}+(D₇×(F−(D_{I}×HP_{I}+D₂))−D₈),

note that this value depends linearly on F for constant HP_{I};

where F_{BP} is the fuel flow at which the engine operates at its best power for the given manifold pressure, rotation rate, and outside air temperature determined by (D_{I}×HP_{I}+D₂), and C_{I}, C₂, F₀, and D₀ through D₈ are coefficients which may be obtained from the engine's manufacturer, obtained by analysis of the engine's design and use, or measured directly by operating the engine under various conditions.

The typical ranges for the coefficients involved are:

A₁ from −100. to 100.;

A₂ from −0.1 to 0.1;

A₃ from −10. to 0.;

A₄ from −0.01 to 0.01;

B from 0.001 to 0.05;

C₁ from 0.01 to 0.1;

C₂ from 0. to 10.;

F₀ from 0. to 10.;

D₀ from 0. to 310.;

D₁ from 0. to 0.1;

D₂ from 0. to 10.;

D₃ from −5. to 15.;

D₄ from −10. to 10.;

D₅ from −10. to 10.;

D₆ from −10. to 10.;

D₇ from −2. to 2.;

D₈ from −5. to 5.

Other embodiments of this invention using similar principles may be used with different engines and under different conditions.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of determining the power of an engine comprising the step of obtaining an HP0, where HP0 is a mathematical combination of a rotation rate of the engine and a manifold pressure of the engine.

2. A method of claim 1 further comprising the step of obtaining an HPI, where HPI is a mathematical combination of an outside air temperature of the engine and of the HP0.

3. A method of claim 2 further comprising the step of obtaining an HPBP, where HPBP is a mathematical combination of a fuel flow rate of the engine and of the HPI.

4. A method of claim 1 wherein the engine is an aircraft engine.

5. A method of claim 1 wherein the mathematical combination is obtained without using a measured altitude of the engine.

6. Apparatus for determining power of an engine comprising:
a computation device calculating power of the engine by mathematically combining a rotation rate of the engine and a manifold pressure of the engine, and
a data input system coupled to the computation device, the data input system providing engine rotation rate and engine manifold pressure to the computation device.

7. Apparatus of claim 6 wherein the computation device calculates the power of the engine by performing further calculations with an outside air temperature of the engine and the data input system further provides the outside air temperature of the engine to the computation device.

8. Apparatus of claim 7 wherein the computation device calculates the power of the engine by performing further calculations with a fuel flow rate of the engine and the data input system further provides the fuel flow rate of the engine to the computation device.

9. Apparatus of claim 6 wherein the engine is an aircraft engine.

10. Apparatus of claim 6 wherein the computation device calculates the power of the engine by performing calculations without using a measured altitude of the engine.

11. A computer program product for determining power of an engine comprising
a computer data carrier, and
computer instructions embodied on the computer data carrier, the computer instructions comprising instructions for calculating an HP0, where HP0 is a mathematical combination of the engine's rotation rate and of the engine's manifold pressure.

12. A computer program product of claim 11 wherein the computer instructions embodied on the computer data carrier further comprise computer instructions for calculating an HPI, where HPI is a mathematical combination of the engine's outside air temperature and of the HP0.

13. A computer program product of claim 12 wherein the computer instructions embodied on the computer data carrier further comprise computer instructions for calculating an HPBP, where HPBP is a mathematical combination of the engine's fuel flow rate and of the HPI.

14. A computer program product of claim 11 wherein the engine is an aircraft engine.

15. A computer program product of claim 11 wherein the computer instructions embodied on the computer data carrier calculate the power of the engine without using the engine's measured altitude.
